(19) United States
(12) Patent Application Publication
(10) Pub. No.: US 2017/0318938 A1
(43) Pub. Date: Nov. 9, 2017

(54) COMPACT CONTAINER HAVING INSERT-MOLDED DISCHARGE PLATE SUPPORTED BY FIXING MEMBER

(71) Applicant: PUM-TECH KOREA CO., LTD, Incheon (KR)

(72) Inventor: Do Hoon LEE, Bucheon-si (KR)

(21) Appl. No.: 15/585,909

(22) Filed: May 3, 2017

(30) Foreign Application Priority Data
May 9, 2016 (KR) 20-2016-2464
Jul. 28, 2016 (KR) 10-2016-95852

(51) Int. Cl. A45D 40/00; A45D 40/22; B05B 11/00; A45D 34/00

(52) U.S. Cl. CPC A45D 40/0075; B05B 11/3002; A45D 34/00; A45D 40/222; A45D 2040/223

(57) ABSTRACT

Provided is a compact container. The compact container includes: an outer container 10; an outer container lid 20 hinged to one side of the outer container 10 so as to be opened and closed; an inner container 30 mounted inside the outer container 10; a discharge device 40 for discharging a cosmetic material; a discharge plate 50 formed adjacent to the discharge device 40 and having a discharge port 52; and a fixing member 60 including a lower fixing member 62 and an upper fixing member 64 to fix the discharge plate 50, wherein the discharge plate 50 is insert-molded between the lower fixing member 62 and the upper fixing member 64, and a top surface of the lower fixing member 62 and a bottom surface of the upper fixing member 64 are integrally molded with each other at an outside of the discharge plate 50 through insert molding.

### CROSS-REFERENCE TO RELATED APPLICATION

This application claims the benefit of Korean application No. 20-2016-2464, filed on May 9, 2016, and Korean application No. 10-2016-95852, filed on Jul. 28, 2016 with the Korean Intellectual Property Office, the disclosure of which is incorporated herein by reference.

### BACKGROUND OF THE INVENTION

### 1. Field of the Invention

The present invention relates to a compact container having an insert-molded discharge plate supported by a fixing member, and more particularly, to a compact container having an insert-molded discharge plate supported by a fixing member, in which a discharge device for discharging a cosmetic material is installed inside the compact container, the discharge device is provided on an upper portion thereof with a discharge plate having a plurality of discharge ports and a fixing member for fixing the discharge plate, and the discharge plate is insert-molded between a lower fixing member and an upper fixing member of the fixing member, so that the productivity may be improved by eliminating an assembly process for the discharge plate, the lower fixing member, and the upper fixing member, and defective products may be prevented from being generated.

### 2. Description of the Related Art

In general, makeup is for making the beautiful part of the body more beautiful, and to complement the weak point of the body. Women perform makeup by using base cosmetic products or color cosmetic products to make their appearance more beautiful.

The makeup cosmetics are classified into a base makeup used for uniformly toning the skin and covering a defect on the skin and a point makeup for partially increasing a three-dimensional effect on lips, eyes, nails and the like, in which the base makeup includes a makeup base, a foundation, a powder and the like, and the point makeup includes a lipstick, an eyeliner, a mascara and the like.

The foundation is classified into a solid foundation, a liquid foundation and a gel foundation according to a type of cosmetic contents. Although the solid foundation produces an effect of excellently covering the skin, the solid foundation may be conglomerated when correcting the makeup, and although the liquid foundation gives a good close contact feel, the persistency of the liquid foundation is weak.

Thus, in recent years, the gel foundation, which gives fresh feelings upon use by imparting a feeling of lightness and moisture, is increasingly used.

In case of filling the gel foundation in a typical container for use, the same amount of cosmetic materials may not be used every time the makeup is performed, and the cosmetic materials are contaminated with bacteria and wastes because a hand of a user or a puff repeatedly makes contact with the cosmetic material.

To solve the problems described above, as shown in FIG. 1, there is provided Korean Patent Registration No. 10-1566114 that discloses a cosmetic container. The related art includes a discharge device for discharging a cosmetic product to the outside, and a discharge plate provided at one side of the discharge device where the cosmetic product is discharged from the discharge device, having at least one discharge port, and exposed to the outside to allow a puff of a user to make contact with the discharge plate, wherein the cosmetic product is discharged from the discharge device as the discharge plate is pressed.

The related art is further provided with a sealing member or a packing material closely interposed between a dispersion part and the discharge plate, so that the cosmetic product may be prevented from leaking to a part other than the discharge port of the discharge plate.

However, since the related art has a structure that the sealing member or the packing material is coupled between a guide plate and the discharge plate to prevent the leakage of cosmetic products, the productivity is decreased due to an increase in an assembly process during the production of products, and defective products are generated in the assembly process.

In addition, when the user presses the discharge plate to perform the makeup, the relate art has a problem that a central portion of the discharge plate is bent into a dispersion space, so that a discharge opening is blocked by the discharge plate.

### SUMMARY OF THE INVENTION

To solve the problems described above, an object of the present invention is to provide a compact container having an insert-molded discharge plate supported by a fixing member, in which a discharge device for discharging a cosmetic material is installed inside the compact container, the discharge device is provided on an upper portion thereof with a discharge plate having a plurality of discharge ports and a fixing member for fixing the discharge plate, and the discharge plate is insert-molded between a lower fixing member and an upper fixing member of the fixing member, so that the productivity may be improved by eliminating an assembly process for the discharge plate, the lower fixing member, and the upper fixing member, and defective products may be prevented from being generated.

In addition, an object of the present invention is to provide a compact container having an insert-molded discharge plate supported by a fixing member, in which the discharge plate is insert-molded between the lower fixing member and the upper fixing member, and a top surface of the lower fixing member and a bottom surface of the upper fixing member are integrally molded with each other at an outside of the discharge plate through insert molding, so that the cosmetic material discharged by the discharge device may be prevented from leaking between the lower fixing member and the upper fixing member.

In addition, an object of the present invention is to provide a compact container having an insert-molded discharge plate supported by a fixing member, in which the lower fixing member of the fixing member is integrally provided at a center thereof with a support part, and a top surface of the support part makes close contact with a central bottom surface of the discharge plate, so that the discharge plate may be prevented from being bent into a dispersion space of the lower fixing member by a pressing force of the user.

According to the present invention, there is provided a compact container including:

an outer container (10);

an outer container lid (20) hinged to one side of the outer container (10) so as to be opened and closed; an inner container (30) mounted inside the outer container (10);

a discharge device (40) for discharging a cosmetic material;

a discharge plate (50) formed adjacent to the discharge device (40) and having a discharge port (52); and

a fixing member (60) including a lower fixing member (62) and an upper fixing member (64) to fix the discharge plate (50),

wherein the discharge plate (50) is insert-molded between the lower fixing member (62) and the upper fixing member (64), and

a top surface of the lower fixing member (62) and a bottom surface of the upper fixing member (64) are integrally molded with each other at an outside of the discharge plate (50) through insert molding.

In addition, the discharge device (40) may include a pump for pumping the cosmetic material accommodated inside the inner container (30).

In addition, the lower fixing member (62) of the fixing member (60) may be provided with a support part (622) making close contact with a center of the discharge plate (50).

In addition, the lower fixing member (62) of the fixing member (60) may be provided with a seating part (624) on which the discharge plate (50) is seated.

In addition, the lower fixing member (62) of the fixing member (60) may be formed with a dispersion space (626) so as to widely disperse the cosmetic material.

In addition, the discharge plate (50) may be formed of a metal, a metal alloy, or a plated metal.

In addition, the discharge plate (50) may be formed of a synthetic resin material or a fiber material.

According to the compact container having the insert-molded discharge plate supported by the fixing member of the present invention, the discharge device for discharging the cosmetic material is installed inside the compact container, the discharge device is provided on the upper portion thereof with the discharge plate having a plurality of discharge ports and the fixing member for fixing the discharge plate, and the discharge plate is insert-molded between the lower fixing member and the upper fixing member of the fixing member, so that the productivity can be improved by eliminating the assembly process for the discharge plate, the lower fixing member, and the upper fixing member, and the defective products can be prevented from being generated.

According to the compact container having the insert-molded discharge plate supported by the fixing member of the present invention, the discharge plate is insert-molded between the lower fixing member and the upper fixing member, and the top surface of the lower fixing member and the bottom surface of the upper fixing member are integrally molded with each other at the outside of the discharge plate through insert molding, so that the cosmetic material discharged by the discharge device can be prevented from leaking between the lower fixing member and the upper fixing member.

According to the compact container having the insert-molded discharge plate supported by the fixing member of the present invention, the lower fixing member of the fixing member is integrally provided at the center thereof with the support part, and the top surface of the support part makes close contact with the central bottom surface of the discharge plate, so that the discharge plate can be prevented from being bent into the dispersion space of the lower fixing member by the pressing force of the user.

### BRIEF DESCRIPTION OF THE DRAWINGS

FIG. 1 shows a cosmetic container according to the related art.

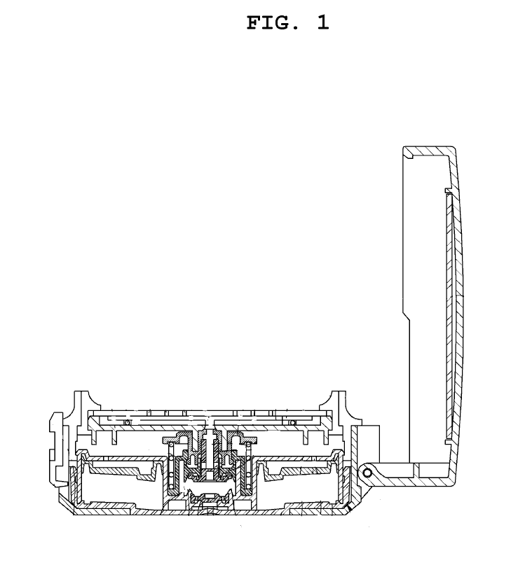

FIG. 2 is a perspective view showing a compact container having an insert-molded discharge plate supported by a fixing member according to the present invention.

FIG. 3 is an exploded perspective view showing the compact container having the insert-molded discharge plate supported by the fixing member according to the present invention.

FIG. 4 is a sectional view showing the compact container having the insert-molded discharge plate supported by the fixing member according to the present invention.

FIG. 5 is a sectional view showing a state that a cosmetic material is discharged by pressing the discharge plate of the compact container having the insert-molded discharge plate supported by the fixing member according to the present invention.

FIG. 6 is a sectional view showing a state that the cosmetic material is introduced into a cylinder upon the release of the pressing force applied to the discharge plate of the compact container having the insert-molded discharge plate supported by the fixing member according to the present invention.

FIG. 7 is a partial perspective view showing the discharge plate and the fixing member of the compact container having the insert-molded discharge plate supported by the fixing member according to the present invention.

FIG. 8 is a partial sectional view showing the discharge plate and the fixing member of the compact container having the insert-molded discharge plate supported by the fixing member according to the present invention.

### DETAILED DESCRIPTION OF THE INVENTION

The compact container having the insert-molded discharge plate supported by the fixing member according to one embodiment of the present invention will be described with reference to accompanying drawings.

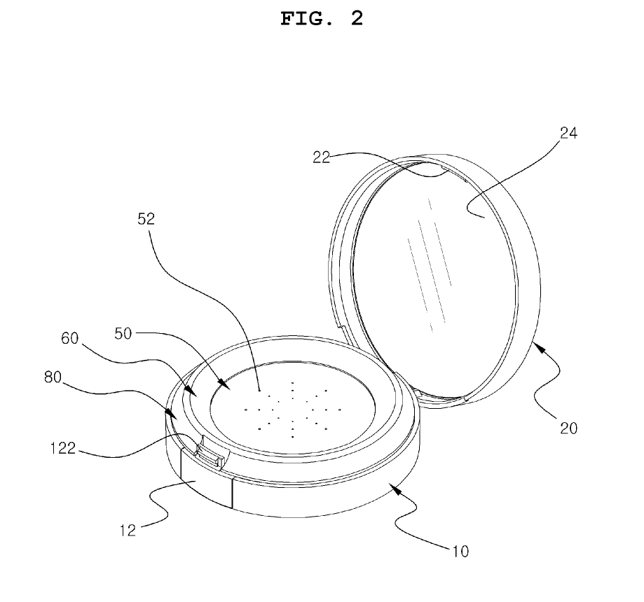

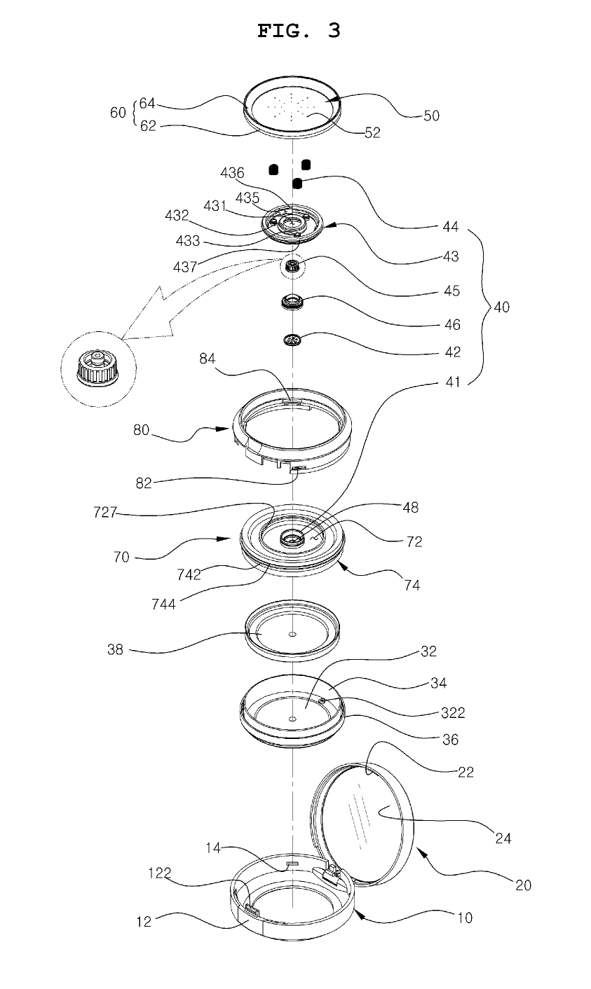

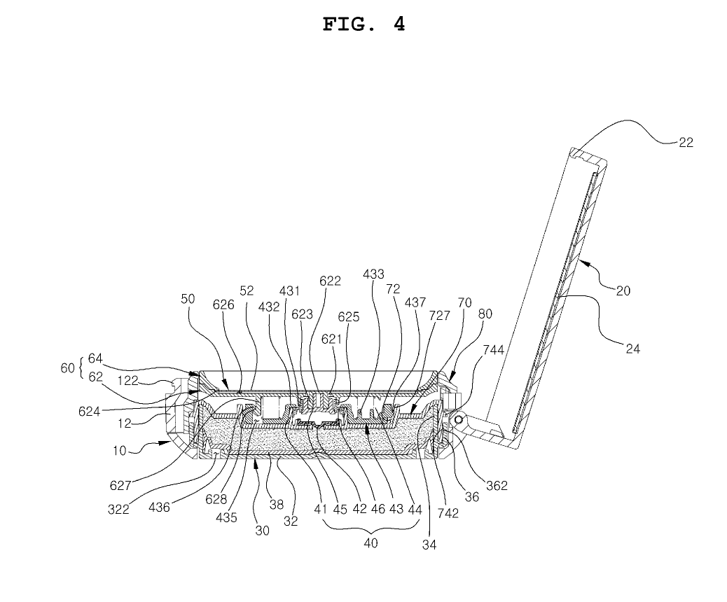

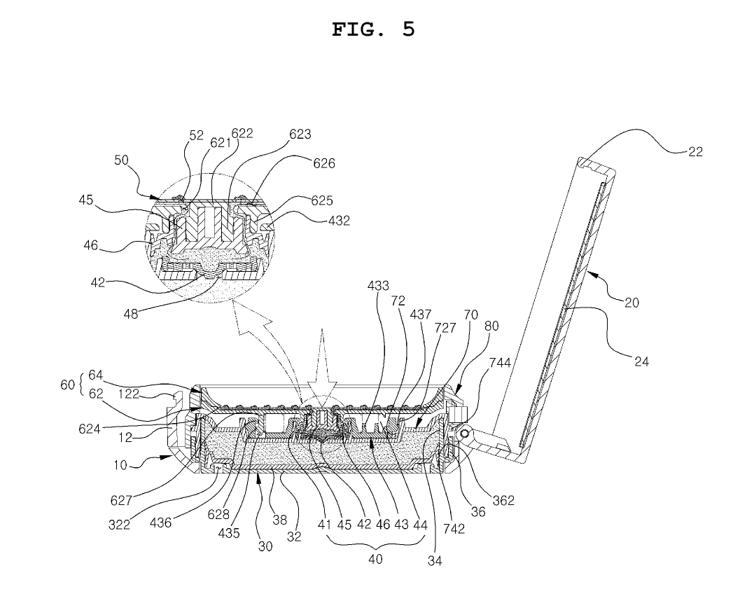

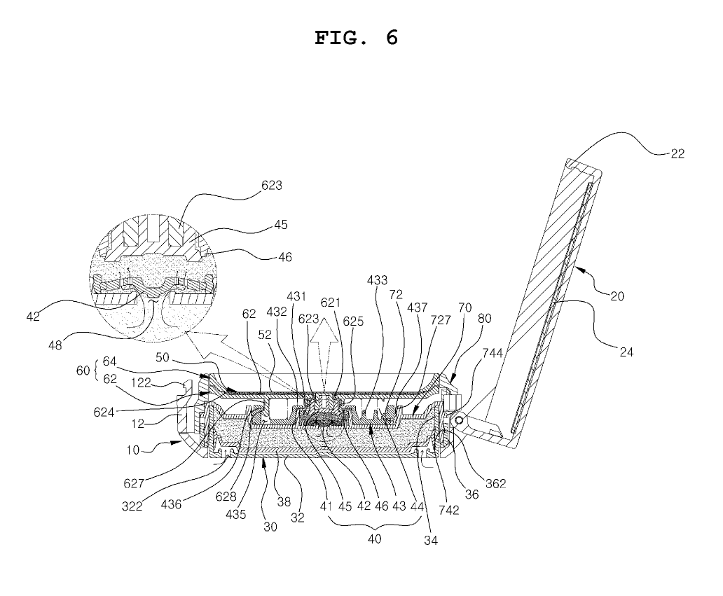

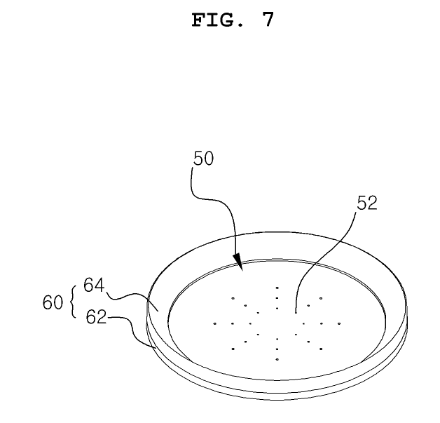

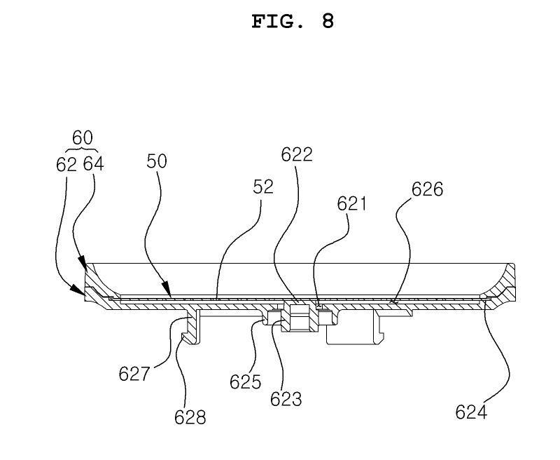

FIG. 2 is a perspective view showing a compact container having an insert-molded discharge plate supported by a fixing member according to the present invention, FIG. 3 is an exploded perspective view showing the compact container having the insert-molded discharge plate supported by the fixing member according to the present invention, FIG. 4 is a sectional view showing the compact container having the insert-molded discharge plate supported by the fixing member according to the present invention, FIG. 5 is a sectional view showing a state that a cosmetic material is discharged by pressing the discharge plate of the compact container having the insert-molded discharge plate supported by the fixing member according to the present invention, FIG. 6 is a sectional view showing a state that the cosmetic material is introduced into a cylinder upon the release of the pressing force applied to the discharge plate of the compact container having the insert-molded discharge plate supported by the fixing member according to the present invention, FIG. 7 is a partial perspective view showing the discharge plate and the fixing member of the compact container having the insert-molded discharge plate supported by the fixing member according to the present invention, and FIG. 8 is a partial sectional view showing the discharge plate and the fixing member of the compact container having the insert-molded discharge plate supported by the fixing member according to the present invention.

According to the present invention, a compact container includes: an outer container 10; an outer container lid 20 hinged to one side of the outer container 10 so as to be opened and closed; an inner container 30 mounted inside the outer container 10; a discharge device 40 for discharging a cosmetic material; a discharge plate 50 formed adjacent to the discharge device 40 and having a discharge port 52; and a fixing member 60 including a lower fixing member 62 and an upper fixing member 64 to fix the discharge plate 50, wherein the discharge plate 50 is insert-molded between the lower fixing member 62 and the upper fixing member 64, a top surface of the lower fixing member 62 and a bottom surface of the upper fixing member 64 are integrally molded with each other at an outside of the discharge plate 50 through insert molding, and the lower fixing member 62 is provided with a support part 622 making close contact with a center of the discharge plate 50, and a seating part 624 on which the discharge plate 50 is seated.

The inner container 30 is mounted inside the outer container 10, and the outer container lid 20 is hinged to one side of the outer container 10.

The outer container 10 is provided at a front surface thereof with a button 12, and a latching protrusion 122 which is moved back by a pressing operation of a user protrudes from an upper portion of the button 12.

A mounting protrusion 14 protrudes from an inner surface of the outer container 10 so as to be coupled with a coupling member 80.

The outer container lid 20 is hinged to one side of the outer container 10 to open and close the outer container 10.

The outer container lid 20 is provided at one side thereof with a protrusion-shaped hook 22 which is disposed at a position corresponding to the latching protrusion 122 of the outer container 10 so as to be coupled to the latching protrusion 122 of the outer container 10.

In addition, the outer container lid 20 may be further provided at an inner side thereof with a mirror 24 for allowing the user to easily perform the makeup.

The inner container 30 is mounted inside the outer container 10, and a gel or liquid cosmetic material is accommodated inside the inner container 30.

The inner container 30 includes an inner container bottom surface 32, an inner wall 34 extending upwards from the inner container bottom surface 32, and an outer wall 36 extending upwards from the inner wall 34 while being spaced outwards from the inner wall 34.

The inner container bottom surface 32 of the inner container 30 is formed with an air passage hole 322 through which external air flows.

The outer wall 36 of the inner container 30 is formed at an inner periphery thereof with a coupling groove 362 coupled with a discharge device support 70.

The inner container 30 is provided at an inner side thereof with a push plate 38 for pushing the cosmetic material upwards, and the push plate 38 makes close contact with an inner surface of the inner container 30.

The inner container 30 is further provided with a plate-shaped discharge device support 70 coupled to the inner container 30, such that the discharge device support 70 is coupled to an upper portion of the inner container 30 to seal the inner container 30.

The discharge device support 70 is integrally provided at a center thereof with a cylinder 41, and the cylinder 41 is formed at an outer side thereof with a bushing installation space 72 in which a bushing 43 of the discharge device 40 is installed.

The bushing installation space 72 of the discharge device support 70 is provided at an outer side thereof with a first fastening annular protrusion 727, and the bushing 43 of the discharge device 40 is provided at an outer periphery thereof with a second fastening annular protrusion 437, such that the second fastening annular protrusion 437 is undercut-coupled to the first fastening annular protrusion 727.

The discharge device support 70 is provided at an outer side thereof with a lower extension annular protrusion 74 extending downwards, the lower extension annular protrusion 74 is provided at an outer periphery thereof with a coupling protrusion 742 coupled to the coupling groove 362 of the inner container 30, and a fixing annular protrusion 744 pressed by the coupling member 80 protrudes from an upper side of the coupling protrusion.

The discharge device 40 is installed in the discharge device support 70 to discharge the cosmetic material accommodated inside the inner container 30 to the outside.

The discharge device 40 may include a pump for pumping the cosmetic material accommodated inside the inner container 30.

The discharge device 40 may include: a cylinder 41 provided at the center of the discharge device support 70 and formed in a bottom surface thereof with a content suction hole 48; a suction valve plate 42 mounted on the bottom surface of the cylinder 41 for selectively opening and closing the content suction hole 48; a bushing 43 mounted on a top of the cylinder 41 and coupled to an outside of the cylinder 41; an elastic member 44 mounted on an upper portion of the bushing 43 or on an upper portion of the discharge device support 70 to elastically support the fixing member 60; a piston 45 provided at an inner side of the cylinder 41; and a piston ring 46 fitted outside the piston 45 and making close contact with an inner surface of the cylinder 41.

The bushing 43 is formed at a center thereof with a through hole 431 through which the piston 45 and the piston ring 46 passes, an inner horizontal extension piece 432 extends inwards of the through hole 431, and the through hole 431 is provided at an outer side thereof with a plurality of elastic member mounting parts 433.

The bushing 43 is provided with a first latching sill 436 coupled with an anti-separation part 627 of the fixing member 60, in which the first latching sill 436 serves to prevent the fixing member 60 from being separated from the compact container.

The discharge plate 50 is formed with a plurality of discharge ports 52 for discharging the cosmetic material pumped by the discharge device 40 to the outside.

The discharge plate 50 may be formed of a synthetic resin material or a fiber material.

When the discharge plate 50 is formed of the synthetic resin material, the discharge plate 50 is preferred to be formed of at least one material among epoxy resins, amino resins, phenol resins, polyester, polyethylene, acrylic resins, polypropylene, polystyrene, polyvinyl chloride, Teflon, nylon, and polyacetal resins.

In addition, the discharge plate 50 may be formed of various materials such as an alloy of a metal and a plated metal.

When the discharge plate 50 is formed of the metal material, the discharge plate 50 may be formed of at least one material among iron (Fe), aluminum (Al), copper (Cu), tungsten (W), stainless steel, nickel (Ni), tin (Sn), titanium (Ti), zinc (Zn), and gallium (Ga).

The fixing member 60 is coupled to an upper portion of the discharge device 40, and fixes the discharge plate 50 while being moved vertically to press the discharge device 40.

As shown in FIG. 7, the fixing member 60 includes the lower fixing member 62 and the upper fixing member 64, and the discharge plate 50 is insert-molded between the lower fixing member 62 and the upper fixing member 64.

In addition, a top surface of the lower fixing member 62 and a bottom surface of the upper fixing member 64 are integrally molded with each other at the outside of the discharge plate 50 through insert molding.

In other words, the lower fixing member 62 is injection-molded, the discharge plate 50 is seated on the support part 622 and the seating part 624 of the lower fixing member 62, and then the upper fixing member 64 is injection-molded, such that the lower fixing member 62 and the upper fixing member 64 are integrally molded with each other at the outside of the discharge plate 50.

Therefore, when the compact container is assembled, the assembling process for the discharge plate 50 and the upper and lower fixing members 64 and 62 is decreased so that the productivity is improved, and the cosmetic material discharged by the discharge device 40 can be prevented from leaking between the lower fixing member 62 and the upper fixing member 64.

As shown in FIG. 8, the lower fixing member 62 is integrally provided at a center thereof with the support part 622 for supporting the discharge plate 50 to prevent the discharge plate 50 from being bent, in which a top surface of the support part 622 makes close contact with a central bottom surface of the discharge plate 50.

The lower fixing member 62 is formed at an outer side thereof with a discharge passage 621 through which the cosmetic material discharged by the discharge device 40 passes.

A first lower extension annular protrusion 623 extends from a lower side of the support part 622 of the lower fixing member 62, and the first lower extension annular protrusion 623 is coupled to the piston 45 of the discharge device 40.

A second lower extension annular protrusion 625 fitted around an outer side of the piston ring 46 of the discharge device 40 extends downwards while being spaced outwards from the first lower extension annular protrusion 623 of the lower fixing member 62 by a predetermined distance.

The second lower extension annular protrusion 625 of the lower fixing member 62 is provided at an outer side thereof with a plurality of anti-separation parts 627 for preventing the fixing member 60 from being separated from the compact container, in which the anti-separation part 627 is provided at a lower side thereof with a second latching sill 628 coupled to the first latching sill 436 of the bushing 43.

The lower fixing member 62 is formed at an upper portion thereof with a dispersion space 626 for widely dispersing the cosmetic material which has passed through the discharge passage 621, and the dispersion space 626 is provided at an outer side thereof with the seating part 624 on which the discharge plate 50 is seated.

The upper fixing member 64 may be formed in a ring shape such that a top surface of the discharge plate 50 is exposed to the outside.

The coupling member 80 may be further coupled to an upper inner side of the outer container 10.

The coupling member 80 presses and fixes the inner container 30 while guiding the discharge plate 50 and the fixing member 60 to move up and down without moving left and right when the discharge plate 50 and the fixing member 60 are pressed.

In addition, the coupling member 80 serves to prevent foreign substances from entering into a gap between the outer container 10 and the inner container 30.

The coupling member 80 is formed at an outer periphery thereof with a mounting groove 82 coupled to the mounting protrusion 14 of the outer container 10, and is provided at an inner periphery thereof with a pressing protrusion 84 protruding to press and fix the fixing annular protrusion 744 of the discharge device support 70.

Hereinafter, a method of assembling the compact container having the insert-molded discharge plate supported by the fixing member, which has a structure as described above, will be described.

As shown in FIGS. 3 and 4, in order to assemble the compact container having the insert-molded discharge plate supported by the fixing member according to the present invention, the outer container 10 having one side hinged to the outer container lid 20 is provided at an inside thereof with the inner container.

Next, the push plate 38 is inserted into the inner container 30, the contents of cosmetic products are injected, and then the discharge device support 70 is coupled to an upper portion of the inner container 30, such that the lower extension annular protrusion 74 of the discharge device support 70 is fitted between the inner wall 34 and the outer wall 36 of the inner container 30 while the coupling protrusion 742 of the lower extension annular protrusion 74 is coupled to the coupling groove 362 of the inner container 30.

Next, discharge device support 70 is provided thereon with the discharge device 40, and the fixing member 60 is coupled to an upper portion of the discharge device 40, such that the anti-separation part 627 of the fixing member 60 is inserted into a fixing member insertion groove 435 of the discharge device 40 while the second latching sill 628 of the anti-separation part 627 is coupled with the first latching sill 436 if the discharge device 40.

At the same time, the first lower extension annular protrusion 623 and the second lower extension annular protrusion 625 are coupled to the piston 45 and the piston ring 46 of the discharge device 40, respectively.

At this time, the top surface of the lower fixing member 62 and the bottom surface of the upper fixing member 64 are integrally molded with each other at the outside of the discharge plate 50 through the insert molding, and the central bottom surface the discharge plate 50 makes close contact with the support part 622 of the lower fixing member 62.

Finally, the coupling member 80 is coupled to the inner upper side of the outer container 10, such that the mounting groove 82 of the coupling member 80 is coupled to the mounting protrusion 14 of the outer container 10 while the pressing protrusion 84 of the coupling member 80 presses and fixes an upper end of the fixing annular protrusion 744 of the discharge device support 70, thereby completing the assembly of the compact container having the insert-molded discharge plate supported by the fixing member according to the present invention.

Hereinafter, a method of using the compact container having the insert-molded discharge plate supported by the fixing member, which is assembled as described above, will be described.

In order to use the compact container having the insert-molded discharge plate supported by the fixing member according to the present invention, first, the top surface of the discharge plate 50 is pressed as shown in FIG. 5.

When the discharge plate 50 is pressed, the fixing member 60 insert-molded with the discharge plate 50 and piston 45 and the piston ring 46 of the discharge device 40 coupled at the lower side of the fixing member 60 are also moved downwards together, thereby reducing the volume inside the cylinder 41.

Accordingly, a pressure is generated inside the cylinder 41, and the contents inside the cylinder 41 are urged to be discharged to the outside by the pressure, which generates a discharge pressure, so that the suction valve plate 42 closes the content suction hole 48 formed in the bottom surface of the cylinder 41.

At the same time, the contents accommodated inside the cylinder 41 flow between the piston 45 and the piston ring 46 and pass through the discharge passage 621 of the lower fixing member 62, and then the contents are discharged to the discharge port 52 of the discharge plate 50 through the dispersion space 626 of the lower fixing member 62.

Thereafter, when the pressing force applied to the discharge plate is released as shown in FIG. 6, the fixing member 60 is moved upwards by the elasticity of the elastic member 44 that elastically supports the fixing member 60, and the piston 45 and the piston ring 46 coupled to the lower side of the lower fixing member 62 of the fixing member 60 are also moved upwards together, so that the volume inside the cylinder 41 is increased, thereby generating a vacuum pressure.

The content suction hole 48 formed in the bottom surface of the cylinder 41 is opened as the suction valve plate 42 is lifted by the vacuum pressure generated inside the cylinder 41, so that the contents accommodated inside the inner container 30 are introduced into the cylinder 41 through the content suction hole 48 while the push plate 38 installed inside the inner container 30 moves upwards.

As described above, although the compact container having the insert-molded discharge plate supported by the fixing member according to one embodiment of the present invention has been described for illustrative purposes, the present invention is not limited thereto. It is understood that various changes and modifications can be made by those skilled in the art without departing from the spirit and scope of the present invention as disclosed in the accompanying claims.

What is claimed is:

1. A compact container comprising:
an outer container (10);
an outer container lid (20) hinged to one side of the outer container (10) so as to be opened and closed;
an inner container (30) mounted inside the outer container (10);
a discharge device (40) for discharging a cosmetic material;
a discharge plate (50) formed adjacent to the discharge device (40) and having a discharge port (52); and
a fixing member (60) including a lower fixing member (62) and an upper fixing member (64) to fix the discharge plate (50),
wherein the discharge plate (50) is insert-molded between the lower fixing member (62) and the upper fixing member (64), and
a top surface of the lower fixing member (62) and a bottom surface of the upper fixing member (64) are integrally molded with each other at an outside of the discharge plate (50) through insert molding.

2. The compact container of claim 1, wherein the discharge device (40) includes a pump for pumping the cosmetic material accommodated inside the inner container (30).

3. The compact container of claim 1, wherein the lower fixing member (62) of the fixing member (60) is provided with a support part (622) making close contact with a center of the discharge plate (50).

4. The compact container of claim 1, wherein the lower fixing member (62) of the fixing member (60) is provided with a seating part (624) on which the discharge plate (50) is seated.

5. The compact container of claim 1, wherein the lower fixing member (62) of the fixing member (60) is formed with a dispersion space (626) so as to widely disperse the cosmetic material.

6. The compact container of claim 1, wherein the discharge plate (50) is formed of a metal, a metal alloy, or a plated metal.

7. The compact container of claim 1, wherein the discharge plate (50) is formed of a synthetic resin material.

8. The compact container of claim 1, wherein the discharge plate (50) is formed of a fiber material.
